(19) United States
(12) Patent Application Publication
(10) Pub. No.: US 2014/0054184 A1
(43) Pub. Date: Feb. 27, 2014

(54) Apparatus, Method and System for Simultaneously Picking up and Releasing Objects in Bulk

(71) Applicant: Pioneer Hi Bred International Inc., Johnston, IA (US)

(72) Inventors: Steven Michael Becker, Johnston, IA (US); Bruce E. Cadwell, Johnston, IA (US); Jason Michael Cope, Ankeny, IA (US); Gary L. Jaehnel, Des Moines, IA (US); David Dallinger Kurth, Grimes, IA (US)

(73) Assignee: Pioneer Hi Bred International Inc., Johnston, IA (US)

(21) Appl. No.: 14/072,196

(22) Filed: Nov. 5, 2013

Related U.S. Application Data
(62) Division of application No. 13/115,640, filed on May 25, 2011.
(60) Provisional application No. 61/353,506, filed on Jun. 10, 2010.

(51) Int. Cl. B25J 1/00

(52) U.S. Cl. CPC B25J 1/00
USPC 206/216; 294/219; 294/65.5; 294/188; 294/212

(57) ABSTRACT

A seed handling tool includes a handle connected to a working body. The working body includes a working surface, which further includes a plurality of seed retention points. A seed retention source is provided to allow the seed handling tool to pick up and retain seeds at the seed retention points. In some embodiments, the seeds may also be released from the seed retention points. A method for retaining a plurality of seeds by the seed handling tool includes moving the seed handling tool to a position where the working surface is adjacent to a plurality of seeds, and picking up and retaining seeds at a plurality of seed retention points fixed at the working surface. In some embodiments, the method may also include releasing the plurality of seeds from the seed retention points.

### CROSS-REFERENCE TO RELATED APPLICATIONS

The present application claims priority from U.S. Provisional Application No. 61/353,506 filed Jun. 10, 2010, which is hereby incorporated herein by reference in its entirety. The present application is a divisional application of and claims priority from U.S. application Ser. No. 13/115,640, which is hereby incorporated herein by reference in its entirety.

### FIELD OF THE INVENTION

The present invention relates to an apparatus, method and system for picking up objects in bulk, and particularly an apparatus, method and system for picking up seeds.

### BACKGROUND OF THE INVENTION

Traditionally, it has been common to place seeds into holding chucks, or blister packs, and to take the grouping of seeds to a plot for planting or testing. The seeds are configured into rows and columns in a specific pattern, for optimal spacing and orientation. In the past, a person physically dropping seeds one by one into seed packs by hand has accomplished the method of adding seeds to a seed pack. This method creates many problems, and costs seed companies money, time, manpower, and other expensive resources to accomplish. The man-hours associated with manually picking-up and retaining seeds in a defined pattern for enabling secondary applications, methods or processes can, and often does, represent a unnecessary draw on a business's resources.

Having a person place a seed at a time in a well, most times having to fill 96 wells, is very time consuming. The seeds need to be oriented in a specific way, and the operator must be careful not to drop a seed. Therefore, it would take a great deal of time for someone to fill each well of each holding chuck or blister pack.

Because it could take such a long time to fill the holding chucks or blister packs, a company may choose to have multiple employees filling at once, which represents an unnecessary draw on business resources that might otherwise be used for supporting other company needs or activities. This is a reduction of manpower resources and reduces the overall amount of work that a company is able to complete on a day-to-day basis. Having to manually handle bulk seeds will invariably reduce the amount of money that a company is able to make.

In addition to taking manpower resources away from a company, manually handling seeds one at a time has an impact on downstream business needs and activities that rely on timely and efficient handling of seeds. For example, if downstream activities such as testing and planting rely on the ability to quickly separate and package seeds into blister packs, having to manually handle and load seeds into blister packs could be crippling to a business.

Accordingly, there is a need in the art for a more efficient and less time-consuming apparatus, method and system to efficiently handle bulk seeds, including loading seeds by bulk into chucks and blister packs. There is also a need in the art for an apparatus, method and system that could be used to decrease the amount of manpower and resources a business allocates to perform the task of handling seeds in bulk.

### BRIEF SUMMARY OF VARIOUS EMBODIMENTS

It is therefore a principal object, feature, or advantage of the present invention to provide an apparatus, method and system for picking up a plurality of seeds at one time.

Another object, feature, or advantage of the present invention is to provide a method and apparatus for retaining a plurality of seeds on a tool.

Another object, feature, or advantage of the present invention is to provide an apparatus, method and system for transporting a plurality of seeds from a seed tray to a blister pack.

Another object, feature, or advantage of the present invention is to provide an apparatus, method and system for orienting a plurality of seeds on a seed handling tool, and transporting the oriented seeds from a seed tray to a blister pack.

Yet another object, feature, or advantage of the present invention it to provide an apparatus, method and system that allows a user to release a plurality of seeds from a seed handling tool into a blister pack at the same time.

Yet another object, feature, or advantage of the present invention is to provide an apparatus, method and system that allows a user to pick up, retain, transport, and release seeds in a particular arrangement.

Still another object, feature, and advantage of the present invention is to provide an apparatus, method and system that allows seeds from a bulk seed source to be picked up from an unorganized state and to be automatically organized, retained and released in a desired pattern or arrangement.

These and other objects, features, and advantages of the present invention will be apparent to those skilled in the art.

According to one aspect of the invention, a seed handling tool is provided. The seed handling tool includes a handle, a working body, a plurality of seed retention points, and a means for retaining seeds at the plurality of seed retention points. The working body is connected to the handle and contains a working surface. The seed retention points are fixed at the working surface.

According to another aspect of the invention, the seed handling tool further comprises means for releasing seeds from the plurality of seed retention points.

According to another aspect of the invention, a seed handling tool for picking up, retaining, and releasing a plurality of seeds at the same time is provided. The seed handling tool includes a handle and a working body connected to the handle. The working body includes a working surface, a plurality of seed retention points fixed at the working surface, a plurality of working surface ports, and a vacuum manifold. The working surface ports are in communication with the seed retention points, and the vacuum manifold is in communication with the ports. The manifold is also operably connected to a negative pressure source.

According to another aspect of the invention, a seed handling tool for picking up a plurality of seeds at the same time is provided. The seed handling tool includes a handle, a working body connected to the handle and a working surface associated with the working body. The tool also includes a plurality of seed retention points fixed at the working surface, an adhesive at the seed retention points and means for automated release of seeds from the adhesive.

According to another aspect of the invention, a seed handling tool for picking up a plurality of seeds at the same time is provided. The seed handling tool includes a handle, a working body connected to the handle, a plurality of seed retention points, a plurality of magnets located at the seed retention points, and means for simultaneously releasing seeds from seed retention points. The working body also includes a top member and an opposite bottom member having a working surface. The seed retention points are fixed at the working surface, and magnetically active coated seeds are retained at the seed retention points as a result of magnetic flux from the magnets.

According to another aspect of the invention, a method for retaining and releasing a plurality of seeds at the same time is provided. The method includes providing a seed handling tool including a handle, a working body, and a working surface. The tool is maneuvered so that the working surface is positioned atop a plurality of seeds. Seeds are retained at and then released from a plurality of seed retention points fixed at the working surface.

According to another aspect of the invention, a method for picking up, retaining, and releasing a plurality of seeds in a specific configuration is provided. The method includes providing a seed handling tool having a handle, and a working body with a working surface having a plurality of seed retention points. Negative pressure is ported through the working body to the seed retention points. The seed handling tool is then placed atop a plurality of seeds. The seed handling tool picks up and retains seeds at the seed retention points using negative pressure or otherwise vacuum. The seeds are then released from the seed retention points by interrupting communication between a negative pressure source and the seed retention points.

According to another aspect of the invention, a system for automated seed arrangement is provided. The system includes a seed handling tool having a plurality of seed retention points fixed at a working surface of the tool. The system also includes a seed retention source associated with the seed handling tool for retaining seeds at the seed retention points.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is perspective view of a seed handling tool according to one embodiment of the present invention;

FIG. 2A is a sectional view of a seed handling tool configured with magnets and a shielding member in a retention position in accordance with one embodiment of the present invention;

FIG. 2B is an illustration of the shielding member shown in FIG. 2A, in a shielding position in accordance with one embodiment of the present invention;

FIG. 3A is an illustration of a seed handling tool according to one embodiment of the present invention having magnets positioned in proximity to the retention points to retain seeds;

FIG. 3B is an illustration of the magnets in FIG. 3A separated a distance from the seed retention points to release the seeds in accordance with one embodiment of the present invention;

FIG. 4A is a sectional view of a seed handling tool having adhesives positioned at the seed retention points and arms illustrated in a retention position in accordance with one embodiment of the present invention;

FIG. 4B is an illustration of the arms shown in FIG. 4A in a release position in accordance with one embodiment of the present invention;

FIG. 5A is a perspective view of a seed handling tool of the invention;

FIG. 5B is a sectional view taken along line 5B-5B in FIG. 5A illustrating an aperture in the working body in a closed position to retain seeds at the seed retention points in accordance with one embodiment of the present invention;

FIG. 5C illustrates the aperture in FIG. 5B in an open position to release seeds;

FIG. 6A is a sectional view of another seed handling tool of the invention adapted to use negative pressure passed through two layers of ports in a seed retaining position in accordance with one embodiment of the present invention;

FIG. 6B illustrates the ports in FIG. 6A in a seed releasing position in accordance with one embodiment of the present invention;

FIG. 7A is a perspective view of a seed handling tool according to one embodiment of the present invention;

FIG. 7B is a sectional view taken along line 7B-7B in FIG. 7A in accordance with one embodiment of the present invention.

FIG. 8A is a perspective view of seed handling tool according to another embodiment of the present invention;

FIG. 8B is a plan view of the tool in a seed retention position in accordance with one embodiment of the present invention;

FIG. 8C is a plan view of the tool in a seed release position in accordance with one embodiment of the present invention;

FIG. 9 is a block diagram of a system showing another embodiment of the present invention;

FIG. 10 is a perspective view of a system in accordance with one embodiment of the present invention;

FIG. 11 is a perspective view of another system in accordance with one embodiment of the present invention;

FIG. 12 is a perspective view of a seed tray in accordance with one embodiment of the present invention;

FIG. 13 shows a perspective view of a seed handling tool in accordance with one embodiment of the present invention;

FIG. 14 shows a sectional view of the seed handling tool of FIG. 13 in accordance with one embodiment of the present invention; and

FIG. 15 shows a perspective view of a seed tray and a seed handling tool used to pick up a plurality of seeds at substantially the same time in accordance with one embodiment of the present invention

### DETAILED DESCRIPTION

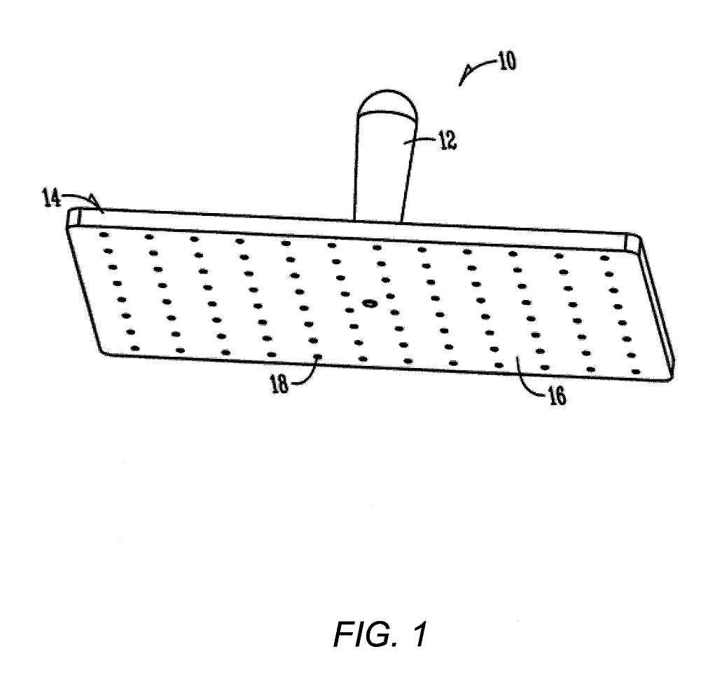

FIG. 1 shows a perspective view of one embodiment of the present invention, namely a seed handling tool 10. The seed handling tool 10 includes a handle 12, which is operably connected to a working body 14. The working body 14 includes a working surface 16, which in the depicted embodiment is a planar surface. The seed handling tool 10 also includes a plurality of seed retention points 18, which are located and fixed at the planar working surface 16. Seeds are retained at each seed retention point 18, and, in some embodiments, may also be released from said points.

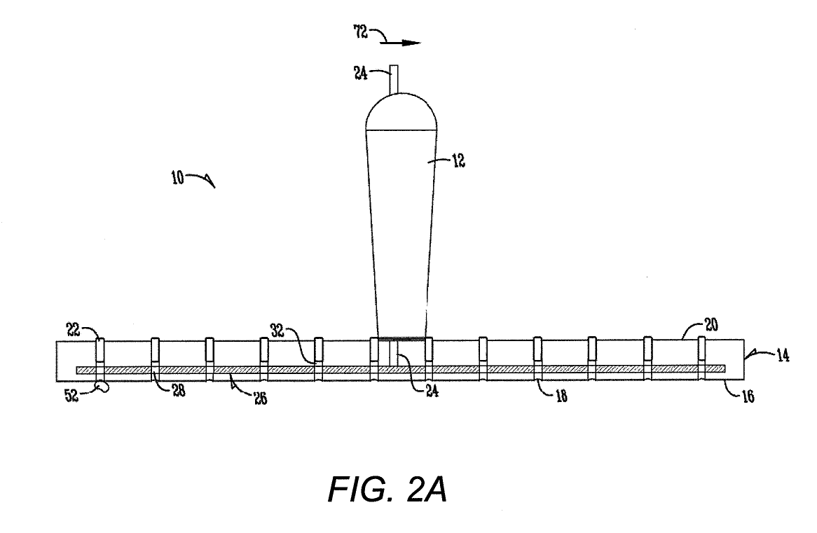

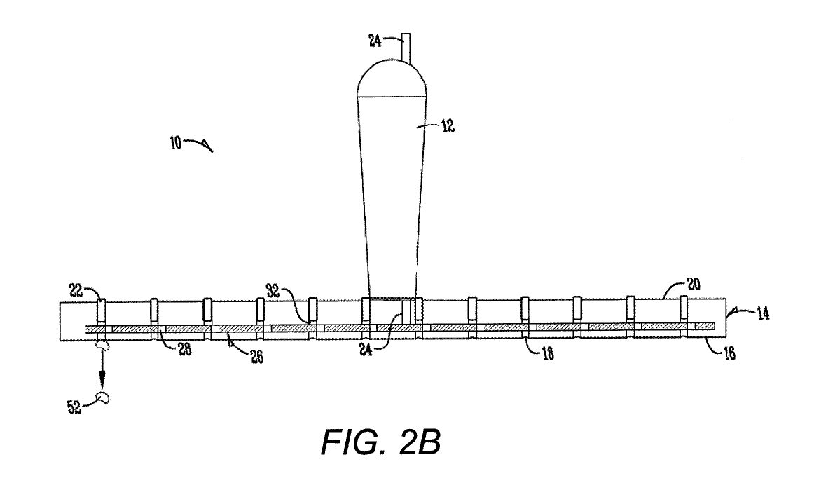

FIG. 2A is a sectional view according to one aspect of the present invention configured with magnets 22 and a magnetic shielding member 26, such as magnetic shielding foil available for purchase through Magnetic Shielding Corporation, 809 Madison Ave., Albany, N.Y. 12208. In FIG. 2A the seed handling tool 10 is illustrated in a retention position adapted to retain seeds at each seed retention point 18. The seed handling tool 10 includes a handle 12 operably connected to a working body 14. The working body 14 includes a planar working surface 16 and an opposite top surface 20. Also included at a fixed location on the working surface 16 is a plurality of seed retention points 18. Each seed retention point 18 is in communication with a port 32 housing a magnet 22. The handle 12 may include an actuator 24 connected to a magnetic shielding member 26 located within the working body 14 between the magnets 22 and seed retention points 18. The magnetic shielding member 26 includes apertures 28. Alternatively, shielding member 26 may include ports comprising a different material than the shielding member 26, such as a material having a substantially greater magnetic permeability to redirect or reroute the magnetic field around the seeds that would otherwise be held at each seed retention point 18. The working body 14 may also include magnets 22 at a fixed position within the working body 14. Although FIG. 2A shows the magnets 22 fixed to the top surface 20 of the working body 14, additional configurations may be used. In the retention position, the apertures 28 of the magnetic shield member 26 are aligned with the magnets 22, which allows the magnetic flux to be directed to the seed retention point 18. When the seed handling tool 10 comes near a seed 52 having a magnetically active coating applied to the entire seed or a single location on the seed, the seed will react to the magnetic flux and will be retained at a seed retention point 18. In a preferred form, the seed is oriented as well as retained by the magnet 22 at the seed retention point 18. The shape of the retention point 18 and/or the location of the magnetically active material on the seed may be used to facilitate orientation in conjunction with retention. As also seen in FIG. 2A, the actuator 24 is moveable in a direction as shown by arrow 72.

Now referring to FIG. 2B, the seed handling tool 10 of FIG. 2A is shown with the magnetic shielding member 26 in a shielding position. In one embodiment of the invention, the actuator 24 is moved in the direction of the arrow 72 (shown in FIG. 2A) to move the magnetic shielding member 26 to a shielding position. As can be seen from FIG. 2B, the apertures 28 of the magnetic shielding member 26 are now misaligned with the magnets 22. Thus, the magnetic shielding member 26 is blocking (i.e., rerouting/redirecting magnetic field lines away from or around the seed retention point 18) the magnetic flux of the magnets 22. Therefore, the magnetically active coating on seed 52 does not feel the effect of the magnetic flux and is no longer retained at seed retention point 18; thus the seed 52 releases from the seed handling tool 10 as shown in FIG. 2B.

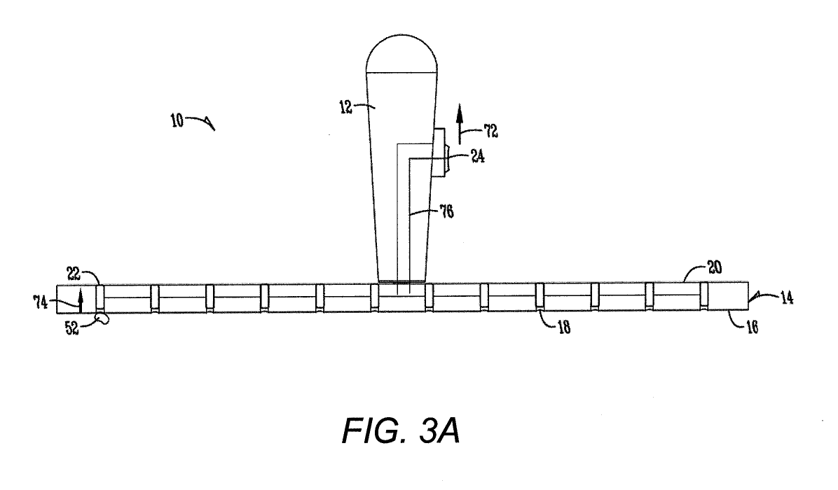

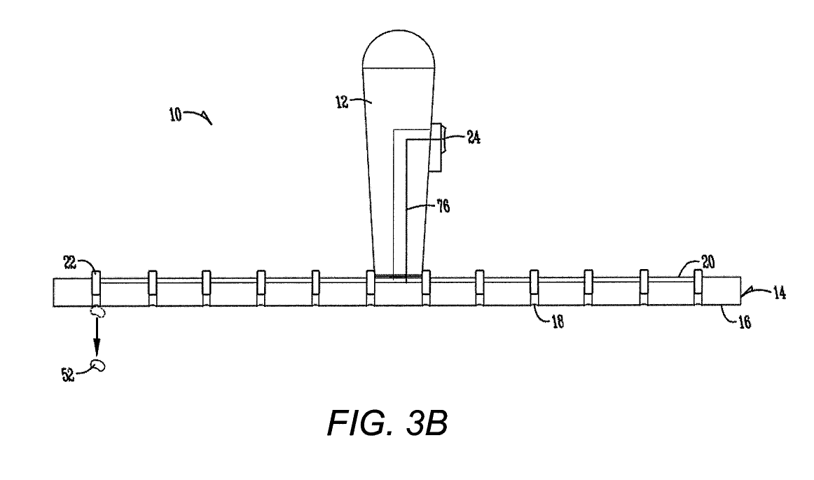

FIG. 3A shows a sectional view of the seed handling tool 10 according to another embodiment of the present invention. FIG. 3A shows the seed handling tool 10 with magnets 22 in a seed retention position. The seed handling tool 10 contains a handle 12 connected to a working body 14. The working body includes a planar working surface 16 and an opposite top surface 20. The planar working surface 16 also includes a plurality of seed retention points 18. The plurality of seed retention points 18 are fixed in location at the working surface 16. The seed handling tool includes an actuator 24, preferably at the handle 12 or within close proximity of the handle or reach of an operator. The actuator 24 is operably connected to magnets 22 by a connection 76. In the present configuration, the magnets 22 are close enough to the seed retention points 18 so that the magnetic flux from each magnet is strong enough at each seed retention point 18 to retain a seed at a retention point 18. The actuator 24 is moveable in a direction shown by arrow 72, which causes the magnets 22 to move in a direction shown by arrow 74. When the actuator 24 and magnets 22 have moved according to the arrows 72 and 74, the result is shown in FIG. 3B, which illustrates the magnets 22 moved to a position away from the seed retention points 18 to release the seed from the seed retention points 18. Movement of the magnets 22 away from the seed retention points 18 moves the magnetic flux farther away from the seed retention points 18, which results in the release of seeds from the seed retention points 18 due to movement of the magnetic flux away from the magnetically active coated seed 52. Thus, the seed 52 is released from the seed handling tool 10 as shown in FIG. 3B by the dotted and solid outlines of the seed 52.

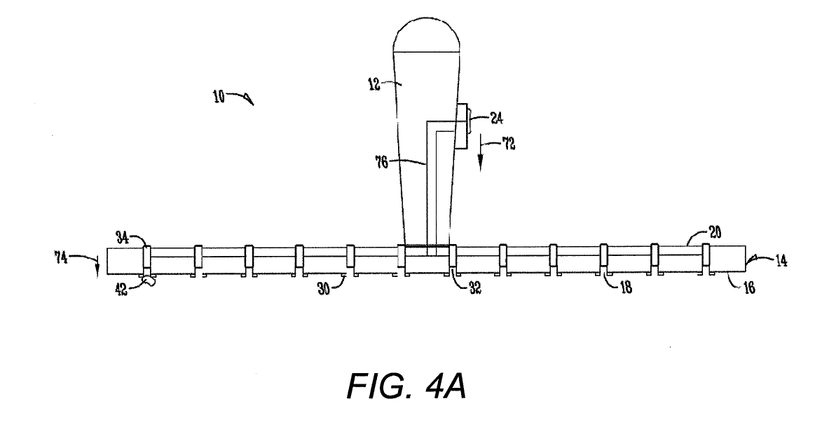

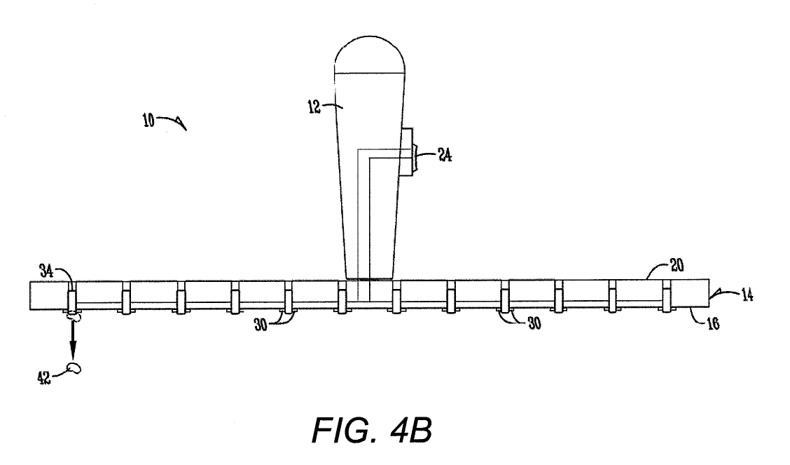

FIG. 4A illustrates a seed handling tool 10 according to another embodiment of the present invention. FIG. 4A shows a sectional view of the seed handling tool 10 having adhesives 30 positioned at a fixed location proximate the seed retention points 18. Arms 34 are operative and change position relative to the seed retention positions 18. The seed handling tool 10 includes a handle 12 connected to a working body 14. The working body 14 includes a planar working surface 16 opposite a top surface 20. The planar working surface 16 also includes a plurality of seed retention points 18 evenly spaced across the surface. The spacing and arrangement of the points 18 may be such to facilitate various seed sizes and various patterns. Adhesives 30 are attached to the planar working surface 16 about the seed retention points 18. The working body also contains ports 32 through the planar working surface 16 of the working body 14. Each port 32 is in communication with a seed retention point 18. The handle 12 contains an actuator 24 operably connected a connection member 76 connecting the actuator 24 to the arms 34. A seed 42 is retained by the adhesive 30 at the seed retention point 18, as shown in FIG. 4A. The present invention contemplates that the adhesive 30 may be replaceable as it becomes less tacky over time, or a type of adhesive that can be reconditioned after each use or multiple uses by rinsing or wiping with a liquid or solution may be used. The actuator 24 and arms 34 are moveable in a direction shown by the arrows 72 and 74 respectively. FIG. 4B shows the seed handling tool 10 of FIG. 4A, but with the arms 34 in a release position. FIG. 4B shows the seed handling tool 10 in a position after the actuator 24 and arms 34 have moved in the direction of the arrows 72 and 74 shown in FIG. 4A. In the release position, the arms 34 protrude through ports 32 and extend downward beyond the planar working surface 16 and the adhesive 30 located at the seed retention point 18 to push off the seed 42 from the seed retention points 18, thus releasing seed 42 from the seed handling tool 10. The actuator 24 and arms 34 are returned to the retention position by moving the actuator 24 in the direction of arrows 72 and 74 illustrated in FIG. 4A.

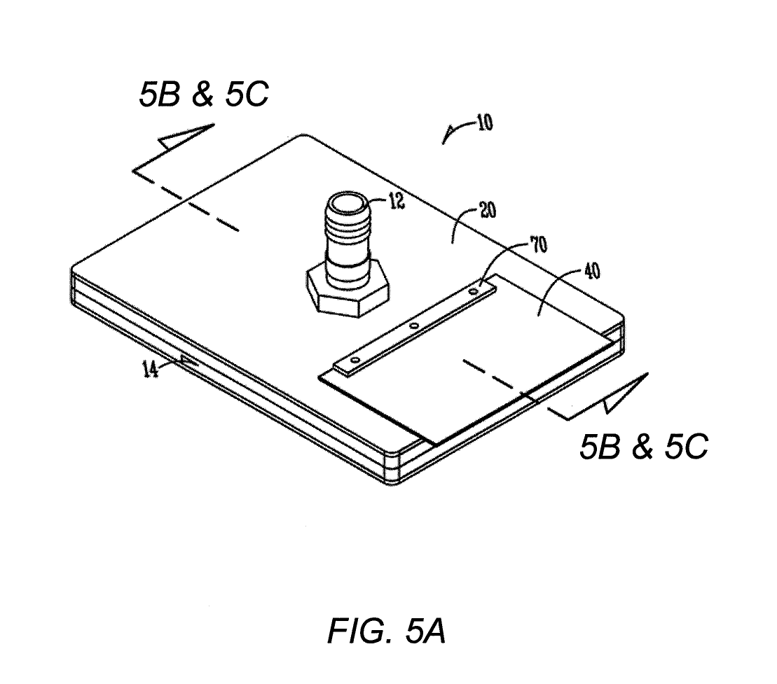

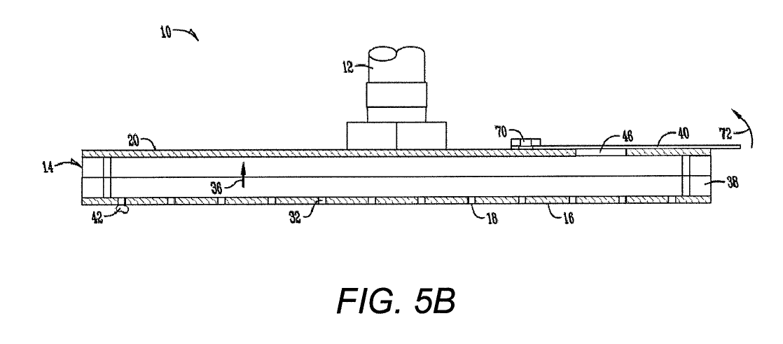

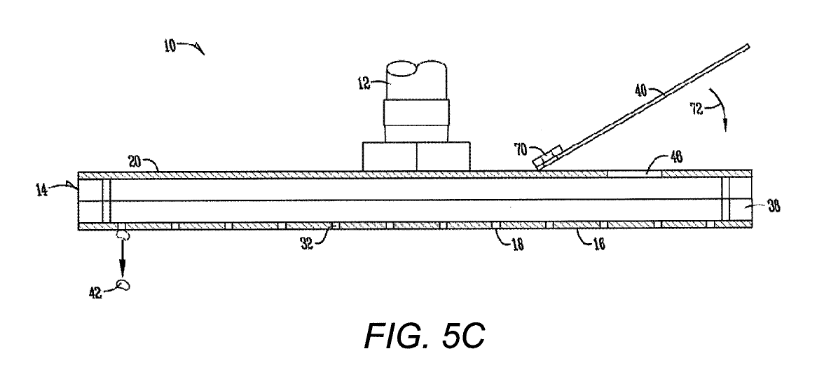

FIG. 5A is a perspective view of a seed handling tool 10 according to another embodiment of the present invention. The seed handling tool 10 illustrated in FIG. 5A is configured to use negative pressure (e.g., vacuum) to retain and release seeds from the seed handling tool 10. As shown in FIG. 5B-C, the seed handling tool 10 includes a handle 12 ported to and in communication with the working body 14. The working body 14 further contains a manifold 38 with ports 32 extending through the planar working surface 16 so as to be in communication with seed retention points 18 of the seed handling tool 10. An aperture 46 is shown passing through a top surface 20 of the working body 14. The aperture 46 is closed by a door 40 operably connected by a hinge 70 connected to the top surface 20 of the working body 14. Although the aperture 46 is shown through the top surface 20 and is shown covered by a hinge door 40, other configurations of the aperture and covering combination are contemplated. Arrow 72 shows the direction the door 40 may be moved. When the door 40 is in a closed position as shown in FIG. 5B, the manifold and seed retention points 18 experience negative pressure, which results in a force acting at each of the seed retention points 18 along the direction of arrow 36. The vacuum force in the manifold retains a seed 42 at each seed retention point 18. FIG. 5C shows the seed handling tool 10 in a release position. In FIG. 5C, door 40 is now in an open position having been moved in the direction of the arrow 72 shown in FIG. 5B. With the door 40 in the open position, the pressure within the manifold goes from a vacuum pressure to the ambient air pressure, which removes negative pressure from the ports 32 and the corresponding seed retention points 18. The result is that the seed 42 is released from the seed retention point 18 as seen by the dotted line and solid line in FIG. 5C. Moving the door 40 in the direction of arrow 72 shown in FIG. 5C back to the closed position causes the manifold pressure to return to the pressure of the vacuum source to which the seed handling tool 10 is connected.

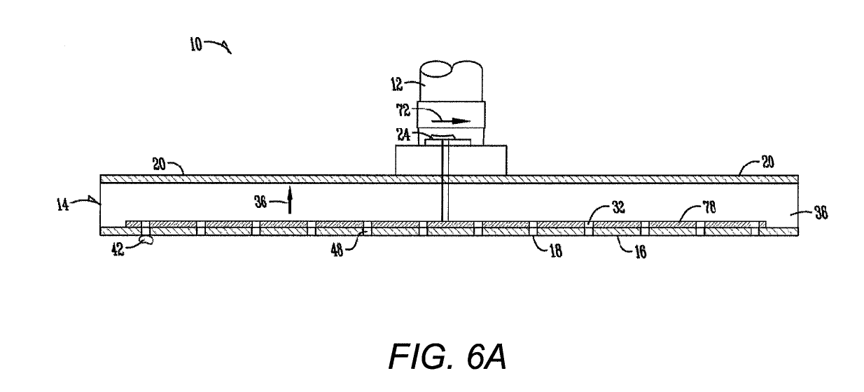

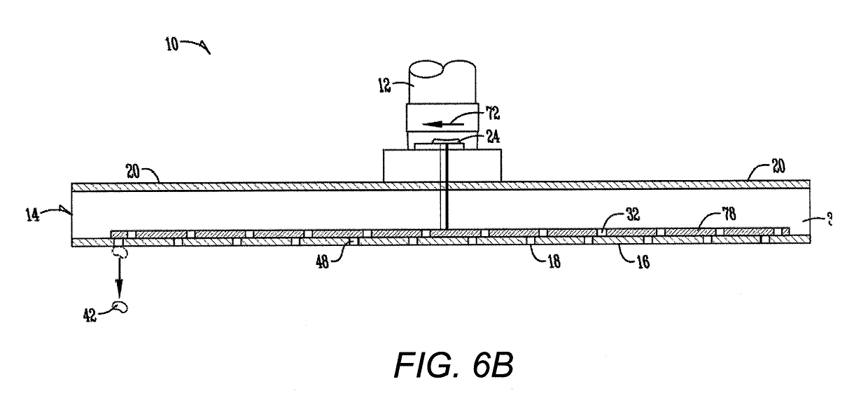

Another embodiment of the present invention is shown in FIG. 6A-B. FIG. 6A shows a seed handling tool 10, which uses negative pressure (e.g., vacuum) to retain seeds at the seed retention points 18. The handle 12 may be connected by a hose to a negative pressure source, such as a vacuum. The working body 14 contains a manifold 38 and a sliding member 78, such as a diaphragm, containing ports 32. An actuator 24 is located on the handle 12 and is operably connected to the sliding member 78. The planar working surface 16 contains working surface ports 48 in communication with the seed retention points 18. The actuator 24 and sliding member 78 are moveable in the direction shown by the arrows 72 in both FIGS. 6A and 6B. In the position shown in FIG. 6A, the seed handling tool 10 is under negative pressure, which results in a force at each seed retention point 18 along the direction of arrow 36 thereby retaining a seed 42 at each seed retention point 18. FIG. 6B shows the seed handling tool 10 in a release position. In FIG. 6B, the actuator 24 and sliding member 78 have been moved in the direction shown by the arrow 72 in FIG. 6A. The ports 32 and working surface ports 48 are no longer aligned (see FIG. 6B), thus the negative pressure is no longer communicated to each seed retention point 18, which allows the seed 42 to be released from the seed retention points 18.

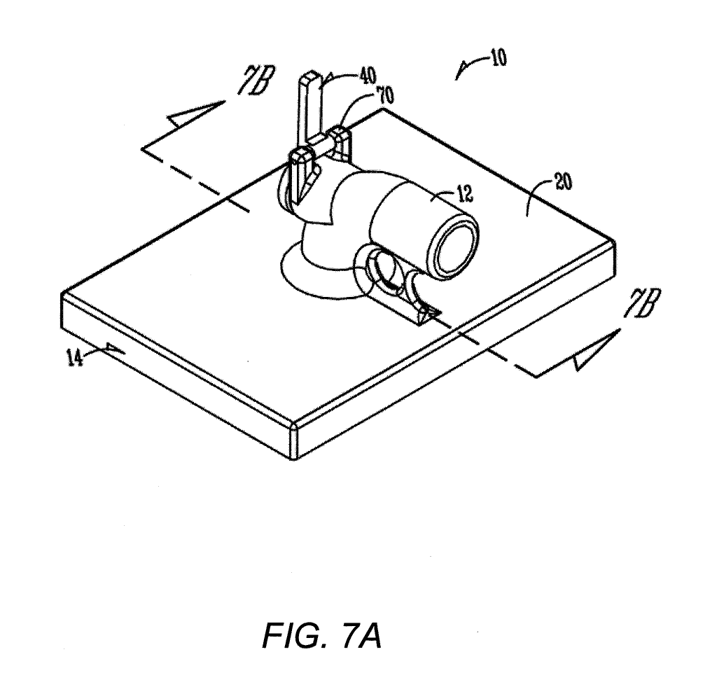

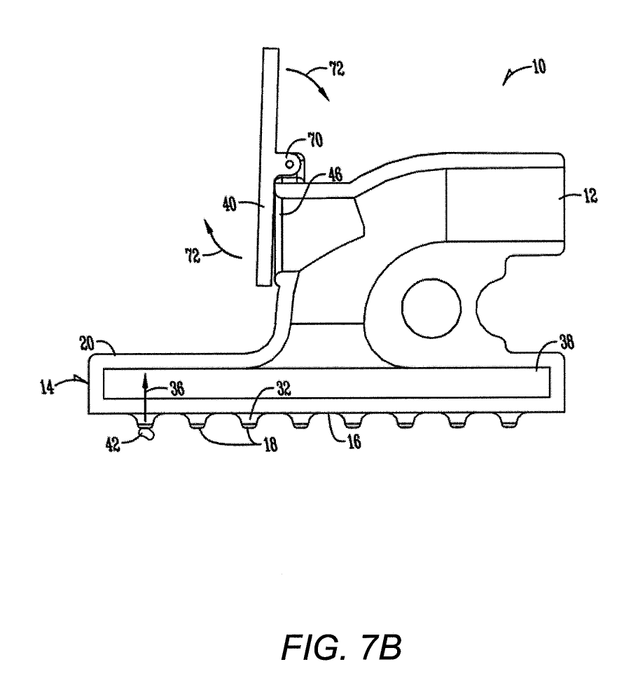

FIGS. 7A-B illustrate another vacuum operated seed handling tool 10. The seed handling tool 10 includes a handle portion 12 connected to the top surface 20 of working body 14. The handle portion 12 is adapted for connecting a negative pressure source such as a vacuum. The handle and vacuum or negative pressure source may be connected by a hose or tube. Alternatively, a negative pressure source may be included or integral to the seed handling tool 10 and made operable by connecting to a source of electricity. The handle 12 includes a door 40 hingedly attached via hinge 70 and handle portion 12. The pressure within working body 14 is controlled by opening and closing door 40.

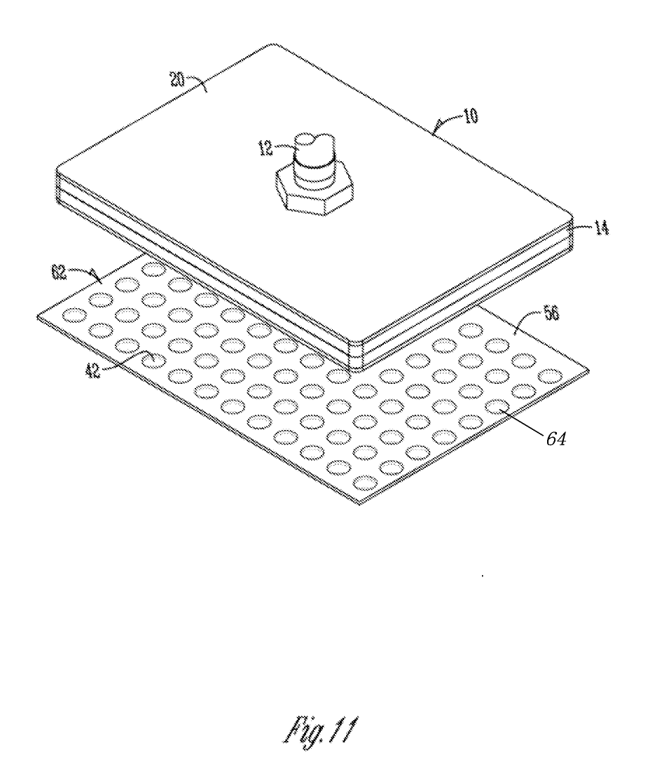

FIG. 7B illustrates a sectional view of seed handling tool 10 taken along line 7B-7B in FIG. 7A. The working body 14 of seed handling tool 10 includes a manifold portion 38 providing communication of negative pressure from the handle portion 12 to seed retention points 18. The working body 14 includes a planar working surface 16. A plurality of seed retention points 18 are fixed at locations along the planar working surface 16 in a desired pattern and arrangement. For example, the plurality of seed retention points 18 may be arranged along the plane of working surface 16 in a desired number of rows and columns or other multi-position arrays. Each seed retention point 18 is in communication with a port 32 that is also in communication with manifold 38. Negative pressure vacuum is communicated from a source through handle 12 into manifold 38 of seed handling tool 10. A negative pressure field is established within the working body 14 of seed handling tool 10 thereby creating a force acting at each seed retention point 18 along arrow 36. A seed 42 is retained at each seed retention point 18 as a result of the negative pressure within manifold 38. To remove the negative pressure field within manifold 38, door 40 is rotated about hinge 70 in the direction indicated by arrows 72 to relieve the vacuum pressure within the manifold 38 and allow manifold pressure to return to the ambient pressure. Seed 42 falls or separates from seed retention point 18 when the pressure within manifold 38 returns to the ambient pressure due to the opening of door 40. Closing door 40 returns the pressure within manifold 38 to the pressure of the negative pressure source connected to handle 12. Thus, a plurality of seeds may be selected from a bulk seed source, retained at each seed retention point 18 and thereby arranged in a desired configuration and arrangement for subsequent release into a container, such as a blister pack illustrated in FIG. 11. Alternatively, the seeds arranged by each one of the seed retention points 18 may be released into a test plot for planting.

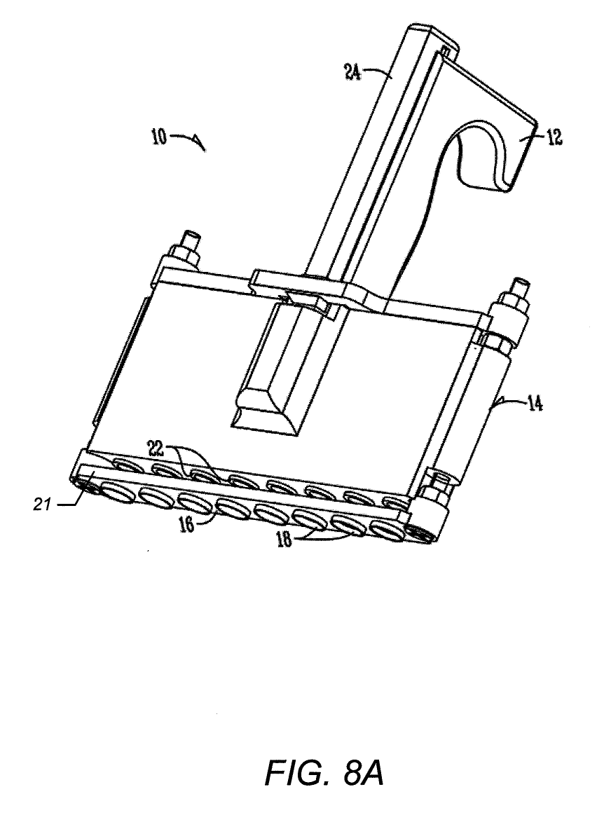

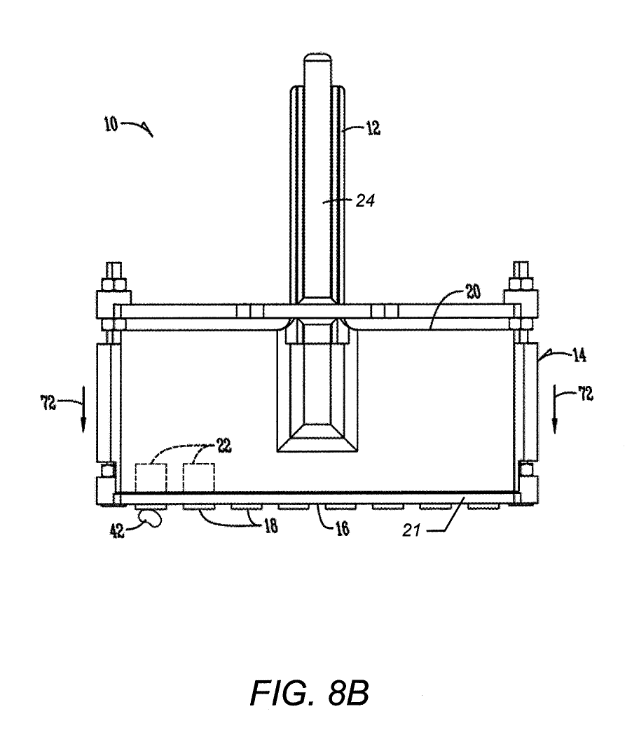

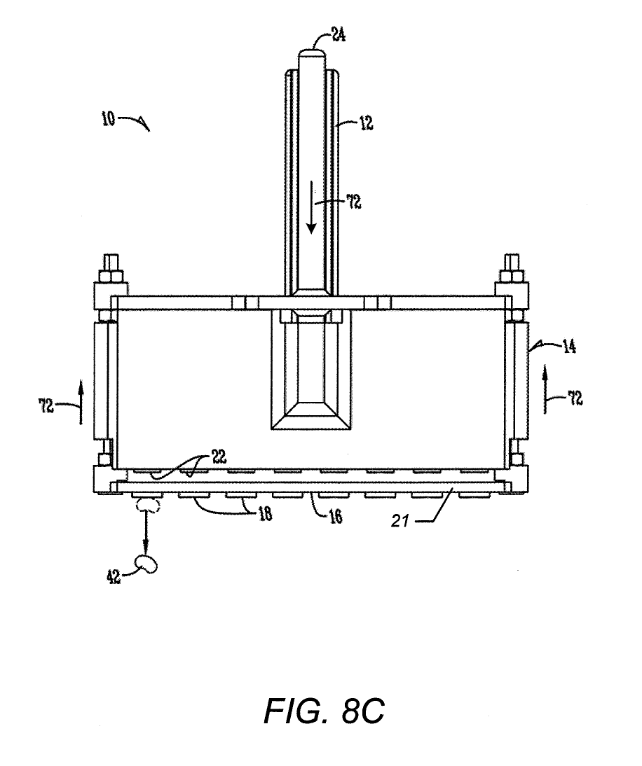

FIGS. 8A-8C illustrate another seed handling tool according to an exemplary aspect of the present invention. FIG. 8A shows a perspective view of the seed handling tool 10 in a seed release position. The seed handling tool 10 includes a handle 12 to which working body 14 is operably attached. An actuator 24 is slidably engaged with working body 14 whereby movement of the actuator 24 imparts movement to a lower cross-bar 21 that includes a working surface 16 having a plurality of seed retention points 18. The actuator 24 extends into the handle 12 to allow for ease of imparting movement while an operator grips the handle portion 12 of seed handling tool 10. The lower cross-bar 21 is connected to the actuator 24 in such a way as to allow the lower cross-bar 21 to translate forward and rearward upon exertion of force to the actuator 24 near handle 12. Various sliding mechanisms that allow the lower cross-bar 21 to translate back and forth relative to handle 12 and working body 14 are contemplated, including pins, rails and other means that permit sliding movement between two bodies. Working body 14 includes a plurality of magnets 22 slightly protruding from the working body 14. The working surface 16 of the lower cross-bar 21 of the seed handling tool 10 includes the plurality of seed retention points 18, and each seed retention point 18 corresponds with a magnet 22 within working body 14.

FIG. 8B illustrates the working body 14 of the seed handling tool 10 in the seed retention position. At rest (i.e., when the actuator 24 is not actuated), the seed handling tool 10 remains in the seed retention position, where the magnets 22 are in close proximity to seed retention points 18. In the depicted embodiment, the seed handling tool 10 remains in the seed retention position because the lower cross-bar 21 is spring loaded against the working body 14. In this case, the seed handling tool 10 is configured to retain the lower cross-bar 21 in the seed retention position until the actuator 24 is actuated, which causes the lower cross-bar 21 to separate from the working body 14. In the seed retention position illustrated in FIG. 8B, seed 42 is retained at each seed retention point 18 due to the magnetic flux from each magnet 22 acting on each seed 42 at each seed retention point 18.

FIG. 8C illustrates the lower cross-bar 21 of the seed handling tool 10 in the seed release position. In the seed release position, the actuator 24 is moved in the direction of arrow 72 such that the lower cross-bar 21 moves away from the working body 14. Movement of the actuator 24 may be accomplished by an operator depressing the actuator 24 at the handle 12 which moves the seed retention points 18 away from the magnets 22 in the working body 14. Movement of the seed retention points 18 in the direction of arrow 72 moves the seed 42 away from the magnetic flux from each magnet 22 thereby allowing the seed 42 to release as illustrated. The seed handling tool 10 illustrated in FIGS. 8A-8C includes a single row of seed retention points 18. The present invention contemplates various arrangements and configurations of rows and columns or other multi-position arrays using seed handling tool illustrated in FIGS. 8A-8C.

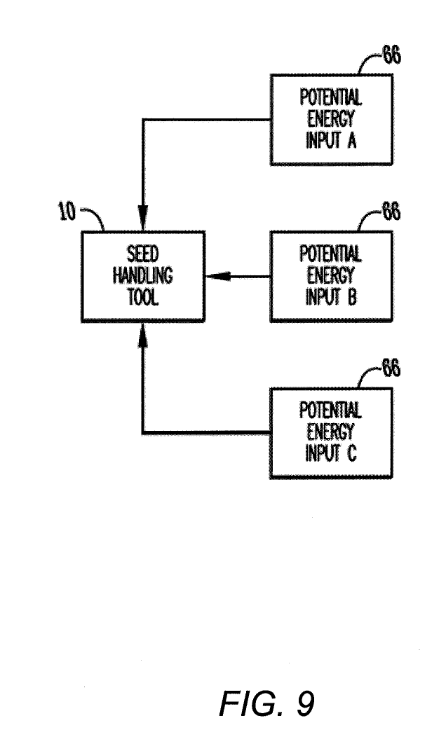

FIG. 9 shows a block diagram of a potential system of the present invention. The system includes a seed handling tool 10 connected to one of many potential energy inputs 66. The seed handling tool 10 contains a plurality of seed retention points 18 fixed at a working surface of the tool 10. Potential energy inputs 66 represent potential sources for picking up, retaining and releasing seeds with the seed handling tool 10. Potential energy input 66 may include a standalone vacuum source connected to the seed handling tool 10 to provide negative pressure, a vacuum source integral with the seed handling tool 10 to provide negative pressure, a standalone electrical source connected to the seed handling tool 10 to provide electricity to the tool, or an electrical source integral with the seed handling tool 10 to provide electricity to the tool 10. Although specific examples have been given, other potential energy inputs 66 may be used to retain the seeds at a plurality of seed retention points 18.

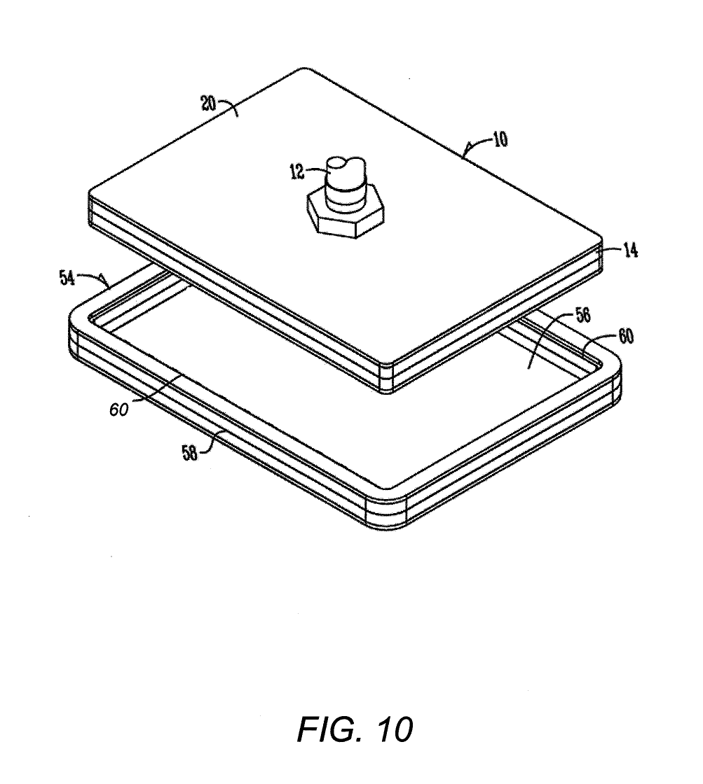

FIG. 10 shows a perspective view of a system in accordance with one embodiment of the present invention. A seed handling tool 10 and a seed tray 54 are provided. The seed handling tool 10 includes a working body 14, a top surface 20, and a handle 12. The seed tray 54 includes a seed tray basin 56, upstanding walls 58, and an interior ledge 60 in the upstanding walls 58. The basin 56 of the seed tray 54 is configured to hold a batch or bulk quantity of seeds.

In use, the working surface of the seed handling tool 10 having the seed retention points 18 is brought into contact with seeds (not shown) located in the basin 56 of the seed tray 54. Retention means, such as negative pressure, magnetic energy, or adhesives, etc. may be used to retain seeds at the seed retention points 18. The retention source causes the seeds to attach to the seed handling tool 10 at the seed retention points 18. The seeds will be aligned and configured in a pattern as defined by the seed retention points 18. The seeds 42 are then retained on the seed handling tool 10 until they are to be released into a storage container, such as blister pack 62 shown in FIG. 9 or planted in a seed plot. FIG. 11 includes the seed handling tool 10 and a blister pack 62. The seed handling tool 10 retains the seeds 42 as previously described. The blister pack 62 contains blister pack wells 64 having the same pattern and spacing as the seed retention points 18 on the seed handling tool 10. The seed handling tool 10 is moved to a position adjacent the blister pack 62, wherein seeds 42 are released from the seed retention points 18 into the wells 64 of the blister pack 62.

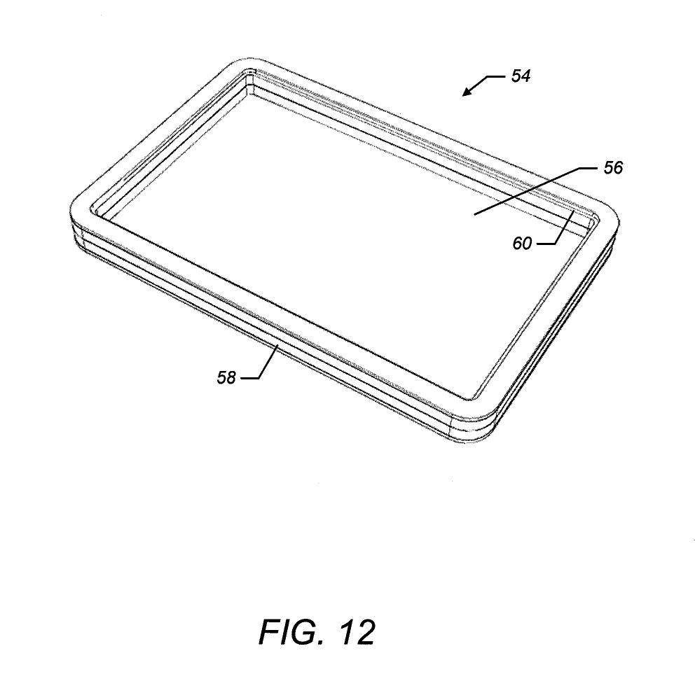

Another embodiment of the present invention is shown in FIGS. 12-15. FIG. 12 shows a seed tray 54 that includes a seed tray basin 56, upstanding walls 58, and an interior ledge 60 in the upstanding walls 58. The basin 56 of the seed tray 54 is configured to hold a batch or bulk quantity of seeds.

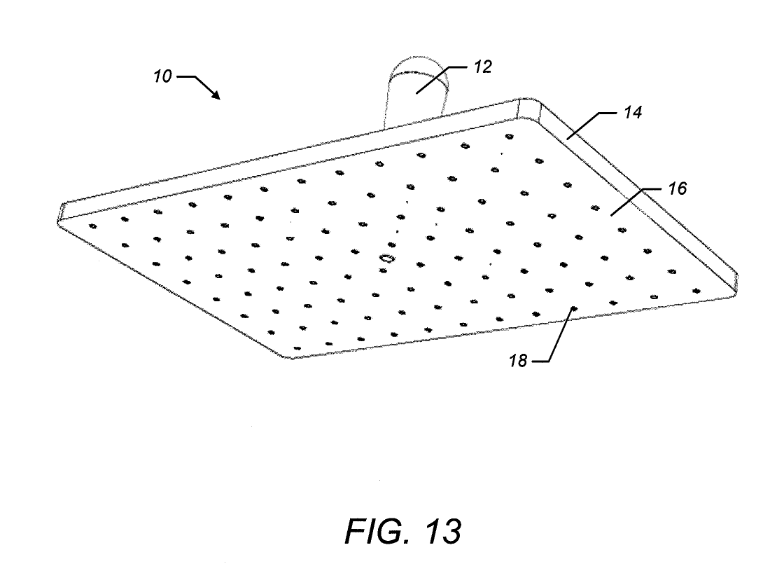

FIG. 13 shows a perspective view of a seed handling tool 10 in accordance with one embodiment of the present invention. In the depicted embodiment, the seed handling tool 10 includes a handle 12, which is operably connected to a working body 14. The working body 14 includes a planar working surface 16 and a plurality of seed retention points 18, which are located at the planar working surface 16. Seeds are retained at each seed retention point 18.

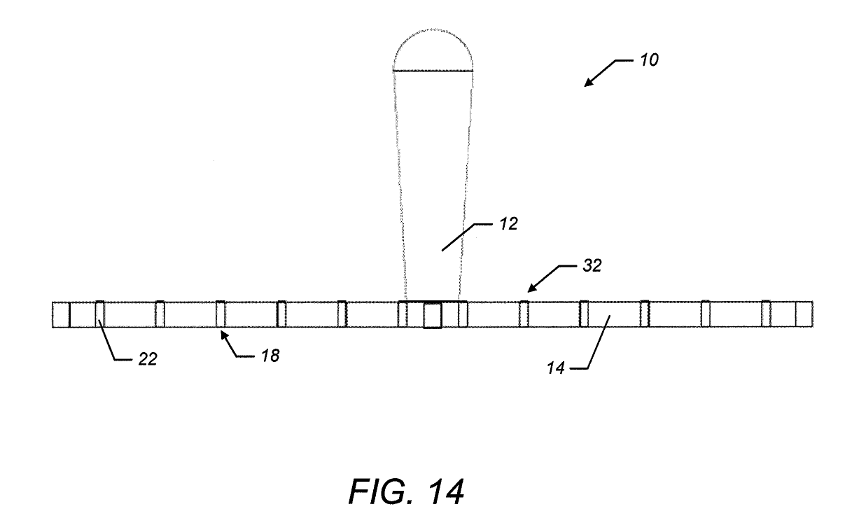

FIG. 14 shows a sectional view of the seed handling tool 10 of FIG. 13 in accordance with one embodiment of the present invention. In the depicted embodiment, the seed handling tool 10 includes a plurality of magnets 22 each of which is located inside a port 32 of the working body 14 of the seed handling tool 10. In this embodiment, a magnet 22 is fixedly located in each of the ports 32 such that an end of each magnet 22 extends proximate the seed retention points 18.

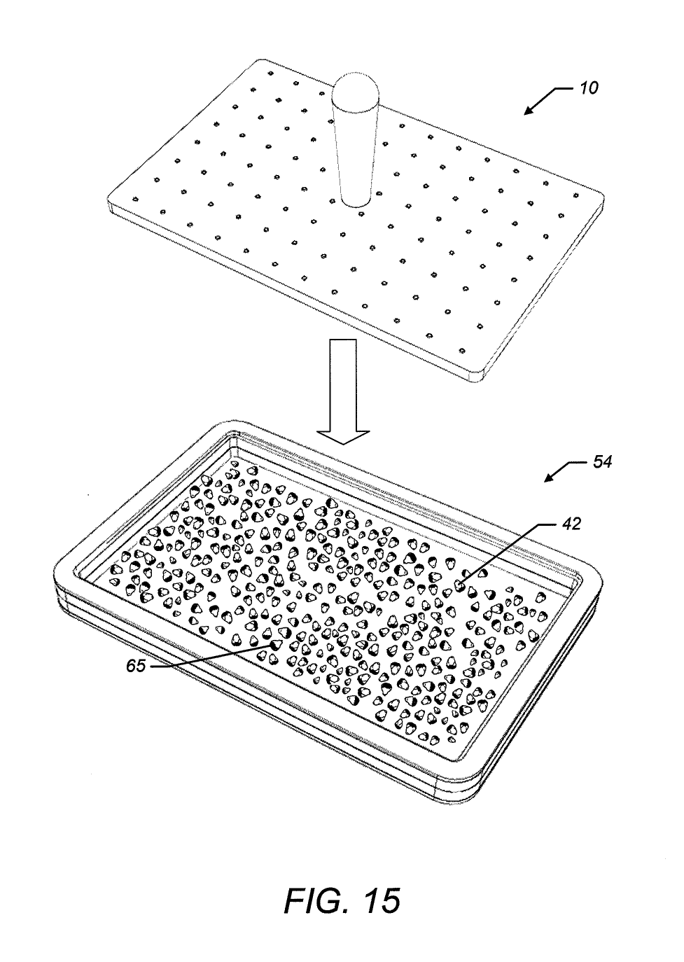

FIG. 15 shows a perspective view of a seed tray 54 and a seed handling tool 10 in accordance with one embodiment of the present invention. The seed handling tool 10 may be used to pick up seeds 42 from the seed tray 54 such that an individual seed 42 is located at each of the seed retention points 18. In the depicted embodiment, this may be accomplished by filling the seed tray 54 with seeds 42, wherein at least a location 65 of each seed 42 has been coated with a magnetically active material. In some embodiments, the seed handling tool 10 may be lowered onto the seed tray 54 so that individual seeds 42 are attracted to the various seed retention points 18 via the magnets 22 located proximate thereto. In other embodiments, the seed handling tool 10 may be lowered onto the seed tray 54 and the seed handling tool 10 and seed tray 54 together may be shaken or vibrated to facilitate movement of the seeds 42 to the seed retention points 18. Although not necessary, excess seeds 42 (i.e., an amount of seeds 42 in excess of the number of seed retention points) may be placed in the seed tray 54. This may further facilitate movement of the seeds 42 to the seed retention points 18.

The exemplary embodiments of the present invention have been set forth within the drawings and in the foregoing description and although specific terms are employed, these are used in the generically descriptive sense only and are not used for the purposes of limitation. Changes in the formed proportion of parts as well as in the substitution of equivalents are contemplated as circumstances may suggest or are rendered expedient without departing from the spirit and scope of the invention as further defined in the following claims.

What is claimed is:

1. A system for automated seed arrangement, comprising:
a seed handling tool having a plurality of seed retention points fixed at a working surface of the tool; and
a seed retention source providing retention of seeds at the seed retention points.

2. The system of claim 1 further comprising a seed tray having a basin surrounded by upstanding walls having an interior ledge, the working surface of the seed handling tool adapted to seat in the interior ledge of the seed tray.

3. The system of claim 2 wherein the seed retention points rest atop a plurality of seeds in the seed tray when the working surface is seated in the interior ledge of the tray.

4. The system of claim 1 further comprising a blister pack having a plurality of wells arrayed in two dimensional rows and columns, wherein the seed retention points have a pattern matching the two dimensional array of rows and columns whereby seeds at the seed retention points are substantially simultaneously released into each well in the tray.

5. The system of claim 1 wherein the seed handling tool further comprises:
a. a handle;
b. a working body comprising the working surface; and
c. a plurality of ports in communication with the plurality of seed retention points.

6. The system of claim 1 wherein the seed retention source comprises at least one of:
a. magnets in communication with the plurality of ports and seed retention points on the working surface;
b. adhesives positioned at the seed retention points; or
c. a negative pressure field introduced into the working body and communicated through the plurality of ports to the seed retention points.

7. The system of claim 1 wherein the seed retention source comprises at least one of:
a. a standalone vacuum source connected to the seed handling tool to provide negative pressure at the seed retention points;
b. a vacuum source integral to the seed handling tool to provide negative pressure at the seed retention points;
c. a standalone electrical source connected to the seed handling tool to provide electricity to the tool; or
d. an electrical source integral to the seed handling tool to provide electricity to the tool.
